(19) United States
(12) Patent Application Publication
(10) Pub. No.: US 2014/0065279 A1
(43) Pub. Date: Mar. 6, 2014

(54) EDIBLE OILS FOR FRYING AND COOKING FOODS HAVING HEALTH BENEFITS

(71) Applicants: Michael Roizen, Shaker Heights, OH (US); Jeffrey Roizen, Philadelphia, PA (US); Jennifer Roizen, Menlo Park, CA (US)

(72) Inventors: Michael Roizen, Shaker Heights, OH (US); Jeffrey Roizen, Philadelphia, PA (US); Jennifer Roizen, Menlo Park, CA (US)

(21) Appl. No.: 14/019,795

(22) Filed: Sep. 6, 2013

Related U.S. Application Data
(60) Provisional application No. 61/697,546, filed on Sep. 6, 2012.

(51) Int. Cl. A23D 9/007; A23L 1/29; A23L 1/01

(52) U.S. Cl. CPC A23D 9/007; A23L 1/0107; A23L 1/293
USPC 426/541; 426/607; 426/438; 426/531

(57) ABSTRACT

A healthy Omega-7 based cooking oil for frying and cooking foods raw or prepared foods. The healthy cooking oil comprises mixture of oils having at least 30%-60% Omega-7, and 70%-30% any healthy or neutral oil. The Omega-7 oil is purified from sea buckhorn and/or its derivatives, algae and/or its derivatives, fish oil and/or its derivatives, and/or macadamia nuts and/or its derivatives. Healthy or neutral oils may be canola oil and walnut oil. The Omega-7 cooking oil may further comprises stabilizers, antioxidants, and polyphenols in an amount not to exceed about 10% or the oil mixture.

### RELATED APPLICATIONS

This application claims priority to U.S. provisional serial no. 61/697,546 filed Sep. 6, 2013, which is hereby incorporated by reference in its entirety.

### FIELD OF THE INVENTION

The invention relates to an edible oil composition, particularly for use in frying and cooking foods both for immediate consumption (French fries), as well as for prepared/stored foods (potato chips, tortilla chips).

### BACKGROUND

The frying process is essentially an operation of dehydrating the food in a bath of oil at a temperature of about 150-200 degrees C. This is a rather complex process, in which two phenomena, namely mass transfer and thermal energy transfer between the components of the food and the oil, take place simultaneously.

The mass transfer consists of the radial migration of the water contained in the inner parts of the food towards the outer surfaces, to replace the water which is eliminated by evaporation from the oil/product interface, this evaporation being due to the rapid increase in the surface temperature of the product which occurs during the frying process. The water migration phenomenon is known as “pumping” wherein the water in the food being fried migrates from the inside and is transferred to the outer parts of the food being fried.

Fried foods may taste good, but metabolism of these foods may carry serious risks to health. Fried foods are often at the top of people's food preferences. This is especially so in certain regional cooking preferences. Unfortunately, consuming fried foods, especially frequently and repeatedly, can lead to serious health implications. For example, a common development related to high consumption of fried foods is aging of the arteries, one manifestation of which is common, or ischemic heart disease. The main reason why fried foods are not healthy to eat is because they have fats that are saturated or trans fats.

Saturated fat is fat that consists of triglycerides containing only saturated fatty acids. Saturated fatty acids have no double bonds between the individual carbon atoms of the fatty acid chain. That is, the chain of carbon atoms is fully “saturated” with hydrogen atoms. Trans fat, on the other hand, is the common name for unsaturated fat with trans-isomer (E-isomer) fatty acid(s). Trans fats are sometimes monounsaturated or polyunsaturated, but never saturated. Trans fats do exist in nature but also occur during the processing of polyunsaturated fatty acids in food production. The consumption of trans fats increases the risk of coronary heart disease by raising levels of LDL cholesterol and lowering levels of “good” HDL cholesterol.

These saturated or trans or denatured-formerly-healthy fats or even omega-6 fats are associated with epigenetic changes, or changes in protein structure, or protein function changes, and/or epigenetic changes, that is, external environmental effects upon genes or proteins that can influence disease. Some of these effects can be inherited in humans. Such changes can indirectly result in inflammation in the body. These epigenetic or related changes commonly lead to thickening the lining of arteries, which can lead to heart attacks and inhibition of the immune system that commonly leads to cancer, and cognitive dysfunction. Fried foods are often cooked in partially hydrogenated vegetable oil which result in trans fats in foods. Trans fats that are included in fried foods have been proven to increase the risk for a person to develop cardiovascular and immune diseases. Eating these foods frequently can increase levels of bad cholesterol and lower levels of good cholesterol, increasing cardiovascular risk as well as causing immune dysfunction. Fried foods can raise blood pressure due to clogged arteries, which then raises a person's risk of suffering from a heart attack, or stroke. Not only can fried foods cause heart disease but they can lead to Type II diabetes, cancer, and cognitive dysfunction as well.

### SUMMARY

Various embodiment illustrated herein relate to an oil that is at least 30% Omega-7 oil (hereinafter referred to as “the healthy oil”) that, when used to fry foods, heats to a temperature that:

constitutes the legal definition of sautéing or frying

brings health benefits such as reducing LDL cholesterol

increases HDL cholesterol

reduces triglycerides

increases insulin sensitivity

reduces obesity

reduces inflammatory markers like hs-CRP

reduces atherosclerosis

reduces memory loss

decreases brain dysfunction.

Examples of omega-7 oils include palmitoleic acid and vaccenic acid. In an embodiment, the Omega-7 oil is purified from sea buckhorn and/or its derivatives. In an alternate embodiment, the Omega-7 oil may be purified from algae and/or its derivatives. In still another embodiment, the Omega-7 oil may be purified in any part from fish oil and/or its derivatives. In a further embodiment the Omega-7 oil may be purified in any part from macadamia nuts and/or its derivatives.

An oil, as illustrated in any of the above embodiments, may have at least 60% palmitoleic acid.

The cooking oil, as noted herein, can be used in cooking, frying, or sautéing and has acceptable taste characteristics that do not significantly change the flavor of the food that is cooked therein.

The cooking oil of the various embodiments may have other oils, or stabilizers or antioxidants or polyphenols added to it that prolongs the life of the oil as its percentage of health giving oils while also prolonging the taste characteristics of the oil.

In an embodiment, the healthy oil is purified (to 50 and 70%) palmitoleic acid without its antagonistic oil, palmitic acid, to sauté and to fry potatoes (French fries and potato chips), other vegetable chips, corn/tortilla chips and chicken and vegetables. By comparison to these foods as fried or sautédin omega-6-rich vegetable oils such as corn or soybean oils, the “French fries,” potato and other vegetable chips, corn/tortilla chips, chicken, vegetables prepared in “the healthy oil,” etc. had lower content of trans- and saturated fats, and higher content of omega-7 oils after cooking. Further, the taste of the “French fries,” chips, chicken, and fried vegetables was not commonly distinguishable from those prepared with oils that have damaging health effects.

Further, the palmitoleic oil fry and sauté mixture also has a high smoking point, boiling point, (160 degrees Celsius), and high temperature at which it degrades. Thus, in contrast to these other oils, such as olive oil, which has a lower smoking/boiling point of 113 degrees Celsius, which typically require replenishment every 4 hours, the healthy, omega-7 based oil lasted 24 hours at a relatively constant frying at over 318 degrees Fahrenheit (159 degrees Celsius) before any evidence of degradation to a non-omega-7 or non-monounsaturated fat occurred.

In the various embodiments, a healthy cooking oil comprising at least of 30% purified omega-7 oil, like palmitoleic acid, used for frying provides health benefits. Further, it can be combined with any healthy or neutral oil such as canola oil, walnut oil, and equivalents thereto. Generally, the higher the percent of palmitoleic in the mixture, the healthier the oil will be and the easier the oil will be use as a substitute for conventional less healthy oils.

A healthy Omega-7 based cooking oil has now been illustrated. Those of ordinary skill in the art will understand that other substitutes for neutral oils may be combined in varying quantities with the Omega-7 oil. Further, the sources from which the Omega-7 oil is derived are not meant to be limiting. One of skill in the art can purify oils and mix oils as needed to provide the inventive compositions.

The inventive oil was found to smoke at 320 degrees Fahrenheit. No deterioration of oil was found up to that temp.

Any reference to claim elements in the singular, for example, using the articles “a,” “an” or “the,” is not to be construed as limiting the element to the singular. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

We claim:

1. An edible oil for frying and cooking foods comprising:
(i) a mixture of oils having at least 30%-60% Omega-7; and
(ii) 70%-30% any healthy or neutral oil.

2. The edible oil for frying and cooking foods of claim 1 wherein the Omega-7 oil is purified sea buckhom and/or its derivatives.

3. The edible oil for frying and cooking foods of claim 1 wherein the Omega-7 oil is purified algae and/or its derivatives.

4. The edible oil for frying and cooking foods of claim 1 wherein the Omega-7 oil is purified fish oil and/or its derivatives.

5. The edible oil for frying and cooking foods of claim 1 wherein the Omega-7 oil is purified from macadamia nuts and/or its derivatives.

6. The edible oil for frying and cooking foods of claim 1 wherein the healthy or neutral oils are taken from the group consisting of canola oil and/or walnut oil.

7. The edible oil for frying and cooking foods of claim 1 further comprising:
stabilizers;
antioxidants; and/or
polyphenols in an amount not to exceed about 10% or the oil mixture.

8. A method for frying or cooking food, the method comprising frying or cooking the food with the edible oil composition according to claim 1.

9. A method for frying or cooking food, the method comprising frying or cooking the food with the edible oil composition according to claim 1, that results in less arterial plaque than with currently used frying oils.

10. A method for frying or cooking food, the method comprising frying or cooking the food with the edible oil composition according to claim 1, that reduces cognitive dysfunction relative to currently used oils.

11. A method for frying or cooking food, the method comprising frying or cooking the food with the edible oil composition according to claim 1, that results in lower LDL cholesterol, and/or higher HDL cholesterol, and/or lower triglyceride levels, and/or increases insulin sensitivity.

12. A method for making the composition according to claim 1, the method comprising mixing the mixture of oils with the healthy or natural oil.

13. A fried or cooked food prepared by the method of claim 8.

14. A fried or cooked food prepared by the method of claim 9.

15. A fried or cooked food prepared by the method of claim 10.

16. A fried or cooked food prepared by the method of claim 11.

17. An edible oil for frying and cooking foods comprising:
(i) a mixture of oils having at least 30%-60% Omega-7; and
(ii) 70%-30% any healthy or neutral oil, wherein the amount of palmitic acid in the edible oil is less than 30% by wt.

18. The edible oil according to claim 17, wherein the amount of palmitic acid in the edible oil is less than 10% by wt.

19. The edible oil according to claim 17, wherein the amount of palmitic acid in the edible oil is less than 1% by wt.
